(19) United States
(12) Patent Application Publication
(10) Pub. No.: US 2011/0105140 A1
(43) Pub. Date: May 5, 2011

(54) APPARATUS AND METHOD FOR CONNECTION SETUP OF COMPONENT CARRIER IN MOBILE COMMUNICATION SYSTEM OF CARRIER AGGREGATION ENVIRONMENT

(75) Inventors: Kyung-Yul Cheon, Daejeon (KR); You Sun Hwang, Seoul (KR); Moon Soo Jang, Daejeon (KR); Aesoon Park, Daejeon (KR)

(73) Assignee: Electronics and Telecommunications Research Institute, Daejeon (KR)

(21) Appl. No.: 12/939,716

(22) Filed: Nov. 4, 2010

(30) Foreign Application Priority Data
Nov. 4, 2009 (KR) 10-2009-0106002
Jul. 22, 2010 (KR) 10-2010-0071008

(51) Int. Cl. H04W 74/00

(52) U.S. Cl. 455/453

(57) ABSTRACT

Provided is an apparatus and method for setting up a connection of a component carrier (CC) in a mobile communication system of a carrier aggregation (CA) environment. In the mobile communication system operating the CA environment, it is possible to change a CC in an initial connection while maintaining a connection state. When a radio link failure and the like occurs, it is possible to quickly change a disconnected CC using a connected component carrier.

### CROSS-REFERENCE TO RELATED APPLICATION

This application claims the benefit of Korean Patent Application No. 10-2009-0106002, filed on Nov. 4, 2009, and Korean Patent Application No. 10-2010-0071008, filed on Jul. 22, 2010, in the Korean Intellectual Property Office, the disclosures of which are incorporated herein by reference.

### BACKGROUND

1. Field of the Invention

The present invention relates to an apparatus and method for setting up a connection of a component carrier in a mobile communication system of a carrier aggregation (CA) environment, and more particularly, to a carrier change procedure and recovery method in the case of load balancing and radio link failure of a mobile communication system in a CA environment.

2. Description of the Related Art

In a mobile communication system, for example, a 3^{rd} Generation Partnership Project (3GPP) Long Term Evolution (LTE) system, an evolved node (eNB) that is a base station has a single carrier for each cell, and a user equipment accesses the carrier to receive a service. In a conventional mobile communication system, a radio link connection and a radio bearer setup procedure of a user equipment may be performed as follows. When a connection is required in a mobile communication network due to a service request from an upper layer and the like, a user equipment camped on a particular cell may start a random access procedure. When a Radio Resource Control (RRC) connection is set up after the random access procedure, the mobile communication system may perform the radio bearer setup procedure.

The mobile communication system, for example, a 3GPP LTE-Advanced system specifies a carrier aggregation (CA) support with respect to multiple carriers in a single cell. In such CA environment, carrier change and recovery needs to be considered within a cell for load balancing, a radio link failure, and the like, however, has not been considered so far.

Specifically, in the case of the radio link failure in a single carrier circumstance, if the user equipment does not access an eNB including user equipment (UE) context, a call may be disconnected whereby a service may be suspended. Even though a connection re-establishment procedure succeeds, a service disconnection may occur. However, in the case of a CA circumstance, even though the radio link failure occurs in a single carrier, a seamless call of the service may need to be maintained by performing a procedure of changing a disconnected carrier to another carrier through a signal procedure using a normal carrier. In addition, a procedure of changing a carrier within a single cell may need to be performed for load balancing and management.

### SUMMARY

An aspect of the present invention provides an apparatus and method for setting up a connection of a component carrier in a mobile communication system of a carrier aggregation environment.

Another aspect of the present invention also provides a component carrier change and recovery method within a cell in the case of load balancing and radio link failure of a mobile communication system in a carrier aggregation environment.

According to an aspect of the present invention, there is provided a method for setting up a connection of a component carrier in a user equipment of a mobile communication system, the method including: performing a random access with an evolved node B (eNB) for acquiring uplink synchronization of the component carrier; transmitting a connection setup request message to the eNB for the connection of the component carrier; receiving a connection setup message from the eNB; setting up a downlink of another component carrier when the other component carrier for connection setup is assigned to the connection setup message; performing the random access with the eNB for acquiring an uplink synchronization of the assigned component carrier; and transmitting a connection setup complete message to the eNB when the random access through the assigned component carrier is completed.

According to another aspect of the present invention, there is provided a method for setting up a connection of a component carrier in an evolved node B (eNB) of a mobile communication system, the method including: setting up a component carrier of a user equipment through load balancing when a connection setup request message is received from the user equipment; generating a connection setup message containing information associated with the component carrier of the user equipment; transmitting the connection setup message to the user equipment; and performing a random access with the user equipment through the component carrier included in the connection setup message.

According to still another aspect of the present invention, there is provided a method of reconfiguring a connection of a component carrier in a user equipment of a mobile communication system, the method including: receiving a connection reconfiguration message from an evolved node B (eNB) through a connected component carrier; setting up a downlink of another component carrier when the other component carrier for connection reconfiguration is assigned to the connection reconfiguration message; performing a random access with the eNB for acquiring uplink synchronization of the assigned component carrier; and transmitting a connection reconfiguration complete message to the eNB when the random access through the assigned component carrier is completed.

According to yet another aspect of the present invention, there is provided a method of changing a connection of a component carrier in an evolved node B (eNB) of a mobile communication system, the method including: determining the change of component carrier of the user equipment for load balancing; setting up the component carrier of the user equipment to be changed and generating a connection reconfiguration message containing information associated with the component carrier of the user equipment to be changed; transmitting the connection reconfiguration message to the user equipment; and performing a random access through the component carrier to be changed.

According to yet another aspect of the present invention, there is provided a method of changing a connection of a component carrier in an evolved node B (eNB) of a mobile communication system, the method including: detecting the event of component carrier of the user equipment for radio link failure or bad radio environment by user equipment; sending the carrier status information to eNB via normal carrier ; setting up the component carrier of the user equipment to be changed and generating a connection reconfiguration message containing information associated with the component carrier of the user equipment to be changed; transmitting the connection reconfiguration message to the user equipment; and performing a random access through the component carrier to be changed.

According to a further another aspect of the present invention, there is provided an apparatus for setting up a connection of a component carrier in a user equipment of a mobile communication system, the apparatus including: at least two component carrier elements, each to communicate with an evolved node B (eNB) using a different component carrier; and a connection setup unit to perform a random access with the eNB for acquiring uplink synchronization of the component carrier, to transmit, to the eNB, a connection setup request message for the connection of the component carrier, and to perform the random access with the eNB for acquiring uplink synchronization of an assigned another component carrier when a connection setup message assigned with the other component carrier for connection setup is received from the eNB.

According to still another aspect of the present invention, there is provided an apparatus for setting up a connection of a component carrier in an evolved node B (eNB) of a mobile communication system, the apparatus including: at least two component carrier elements, each to perform a communication using a different component carrier; and a connection setup unit to set up a component carrier of a user equipment through load balancing when a connection setup request message is received from the user equipment, to transmit, to the user equipment, a connection setup message containing information associated with the component carrier of the user equipment, and to perform a random access with the user equipment through the component carrier.

According to embodiments of the present invention, there may be provided a component carrier change and recovery method within a cell in the case of load balancing and radio link failure of a mobile communication system in a carrier aggregation environment. In the mobile communication system operating the carrier aggregation environment, a change of a component carrier may be quickly performed in an initial connection while maintaining a connection state. When the radio link failure and the like occurs, it is possible to quickly change a disconnected component carrier using a connected component carrier while seamlessly providing the service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a mobile communication system in a carrier aggregation (CA) environment according to an embodiment of the present invention;

FIG. 2 is a flowchart illustrating a process of changing a connection setup of a component carrier (CC) in a user equipment of a CA environment according to an embodiment of the present invention;

FIG. 3 is a flowchart illustrating a process of changing a connection setup of a CC of a user equipment in an evolved node B (eNB) of a CA environment according to an embodiment of the present invention;

FIG. 4 is a flowchart illustrating a process of re-setting up a CC in a user equipment of a CA environment according to an embodiment of the present invention;

FIG. 5 is a flowchart illustrating a process of re-setting up a connection of a CC of a user equipment in an eNB of a CA environment according to an embodiment of the present invention;

FIG. 6 is a diagram illustrating a process of changing a connection setup of a CC in a mobile communication system of a CA environment according to an embodiment of the present invention; and

FIG. 7 is a diagram illustrating a process of re-setting up a connection of a CC in a mobile communication system of a CA environment according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to embodiments of the present invention, there is provided a component carrier (CC) change and recovery method and apparatus within a cell in the case of load balancing and radio link failure of a mobile communication system in a carrier aggregation (CA) environment.

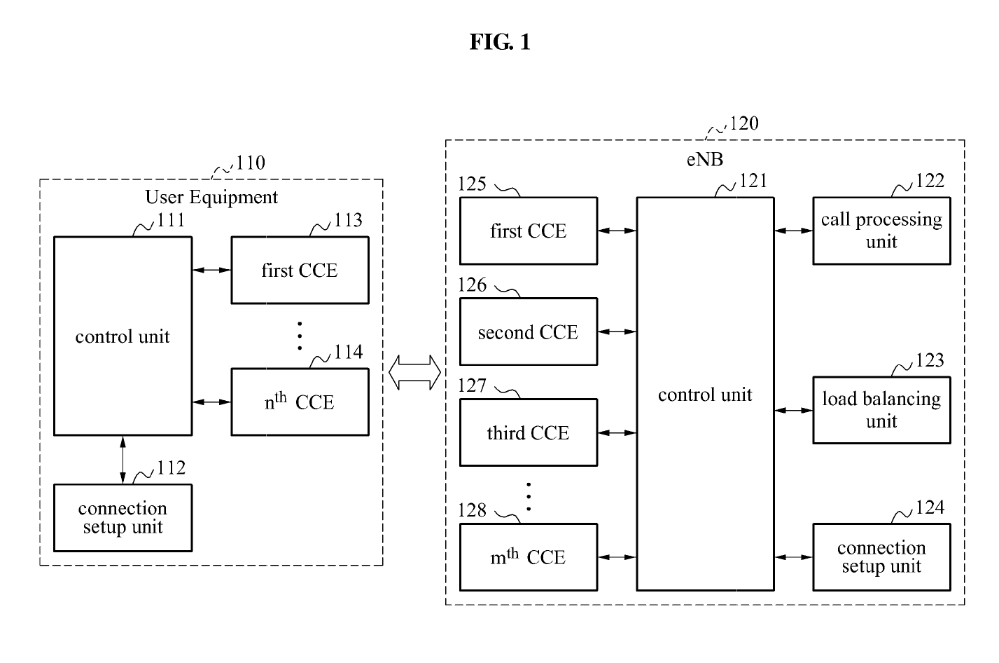

FIG. 1 is a block diagram illustrating a configuration of a mobile communication system in a CA environment according to an embodiment of the present invention.

Referring to FIG. 1, the mobile communication system may include a user equipment 110 and an evolved node B (eNB) 120.

The user equipment 110 may include a control unit 111, a connection setup unit 112, a first component carrier element (CCE) 113, . . . , an n^{th} CCE 114.

Here, each of the first CCE 113, . . . , the n^{th} CCE 114 may communicate with the eNB 120 using a different CC.

The control unit 111 may control a general operation of the user equipment 110, and select a CC set of the user equipment 110 by selecting a CC for each of the first CCE 113, . . . , the n^{th} CCE 114, and may control the user equipment 110 to camp on a cell through the CC selected for each of the first CCE 113, . . . , the n^{th} CCE 114.

The connection setup unit 112 may perform a random access with the eNB 120 for acquiring uplink synchronization of CC. The connection setup unit 112 may transmit, to the eNB 120, a connection setup request message for CC connection. When a connection setup message assigned with another CC for connection setup is received from the eNB 120, the connection setup unit 112 may perform the random access with the eNB 120 for acquiring uplink synchronization of the assigned CC. The connection setup unit 112 may acquire the uplink synchronization through the random access. When the connection setup is completed, the connection setup unit 112 may transmit a connection setup complete message to the eNB 120.

When the connection setup unit 112 receives, from the eNB 120 through the connected CC, a connection reconfiguration message assigned with the other CC for connection reconfiguration, the connection setup unit 112 may set up downlink of the assigned CC. The connection setup unit 112 may perform the random access with the eNB 120 for acquiring the uplink synchronization of the assigned CC. When the connection reconfiguration is completed, the connection setup unit 112 may transmit a connection reconfiguration complete message to the eNB 120.

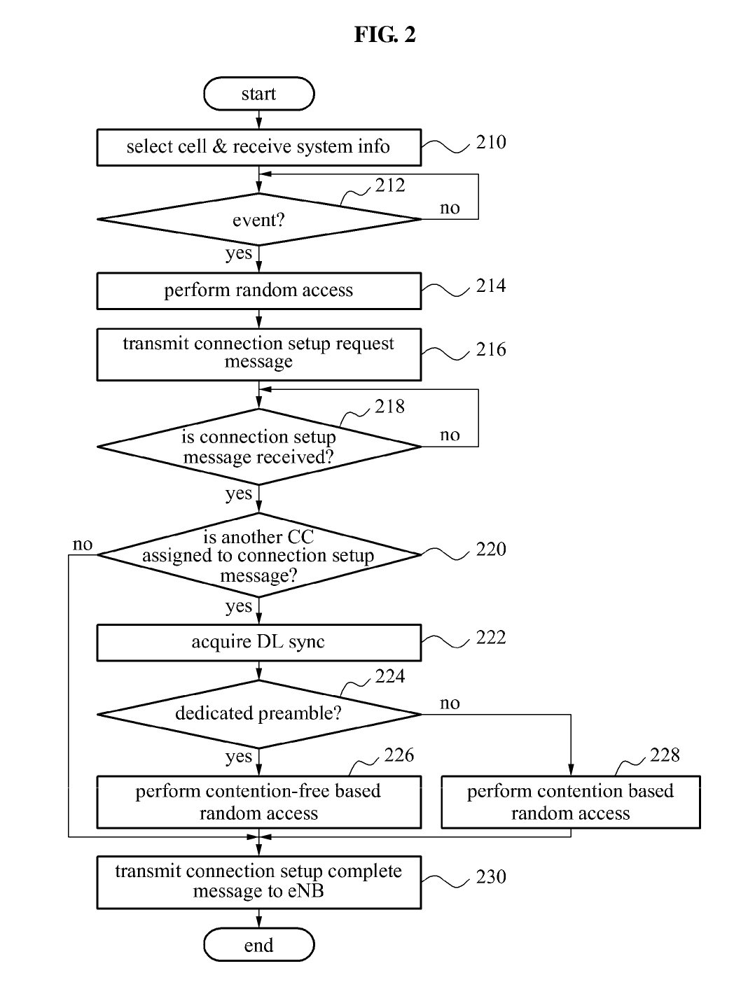

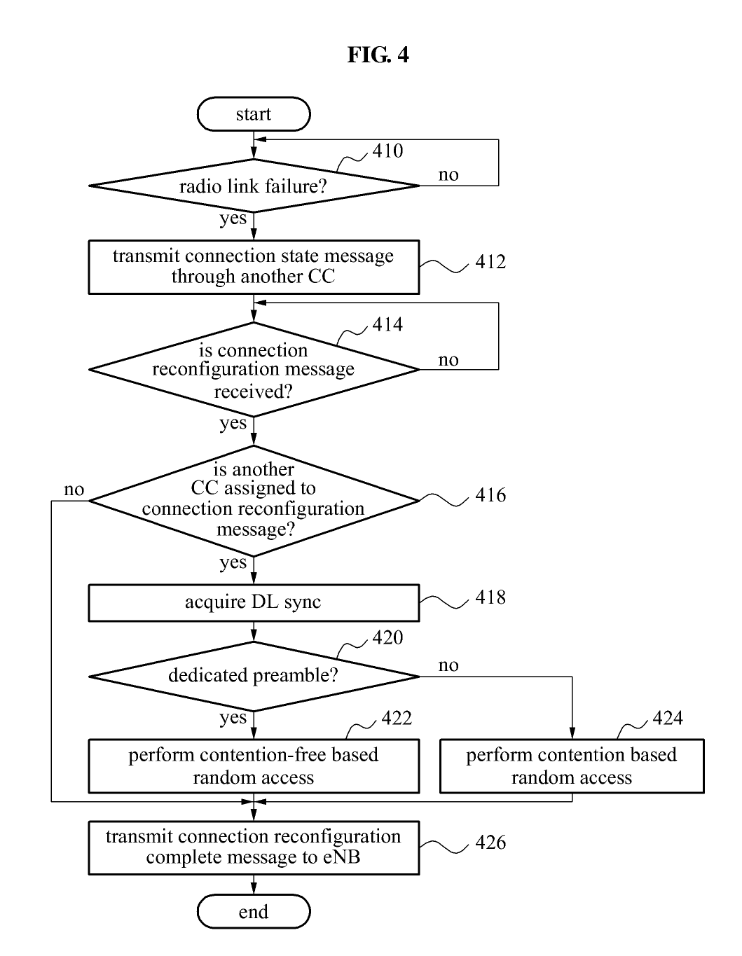

A connection setup of the user equipment 110 will be further described with reference to FIG. 2 and FIG. 4.

The eNB 120 may include a control unit 121, a call processing unit 122, a load balancing unit 123, a connection setup unit 124, a first CCE 125, a second CCE 126, a third CCE 127, . . . , an m^{th} CCE 128.

Each of the first CCE 125, the second CCE 126, the third CCE 127, . . . , the m^{th} CCE 128 may communicate with the user equipment 110 through m CCs used at the eNB 120.

In response to a paging request, the cal processing unit 122 may set up a CC of the user equipment 110.

The load balancing unit 123 may perform load balancing to prevent traffic from being concentrated on a particular CC among CCs used at the eNB 123.

When a connection setup request message is received from the user equipment 110, the connection setup unit 124 may set up a CC of the user equipment 110 that is load balanced through the load balancing unit 123. The connection setup unit 124 may transmit, to the user equipment 110, a connection setup message containing CC information of the user equipment 110, and may perform the random access with the user equipment 110 through the CC. The connection setup unit 124 may receive, from the user equipment 110, a connection setup complete message indicating that the connection setup is completed.

When an event for changing the CC of the user equipment 110 is detected, the connection setup unit 124 may set up the CC of the user equipment 110 that is load balanced through the load balancing unit 123. In this instance, the event may occur when a connection state message indicating that a CC of which a radio connection is disconnected exists is received from the user equipment 110, when a poor connection state of the CC is detected through the first CCE 125, the second CCE 126, the third CCE 127, . . . , the m^{th} CCE 128, or when load balancing using the load balancing unit 123 is required. The connection setup unit 124 may transmit, to the user equipment 110, a connection reconfiguration message containing information associated with the CC of the user equipment 110 to be changed, and may perform the random access through the CC to be changed. The connection setup unit 124 may receive, from the user equipment 110, a connection reconfiguration complete message indicating that a connection reconfiguration is completed.

The control unit 121 may control a general operation of the eNB 120, and may control system information to be transmitted through the first CCE 125, the second CCE 126, the third CCE 127, . . . , the m^{th} CCE 128 at predetermined time intervals.

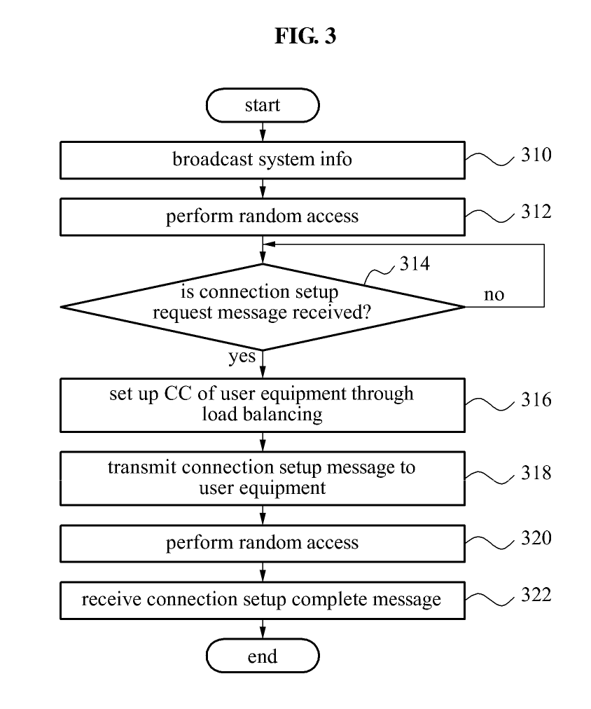

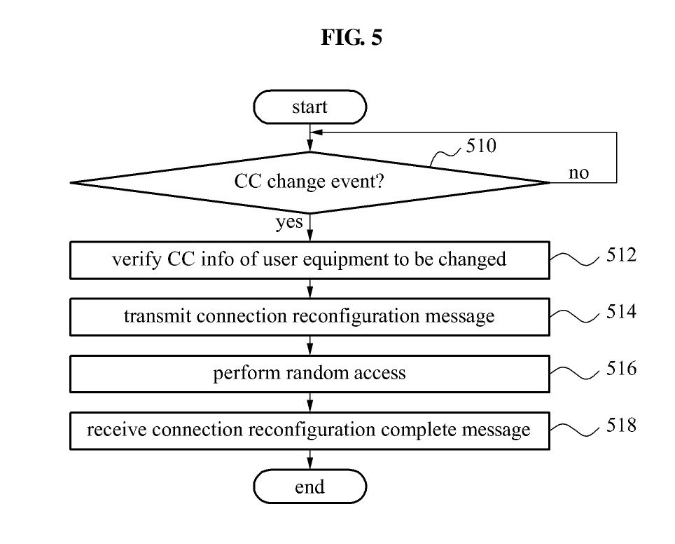

Hereinafter, the connection setup of the eNB 120 will be further described with reference to FIG. 3 and FIG. 5.

A method of changing a CC or recovering radio link failure within a cell when load balancing and radio link failure occurs in the mobile communication system configured as above according to an embodiment of the present invention will be described.

FIG. 2 is a flowchart illustrating a process of changing a connection setup of a CC in the user equipment 110 of a CA environment according to an embodiment of the present invention.

Referring to FIG. 2, in operation 210, the user equipment 110 may receive system information to select a cell and camp on the cell. When a connection event is detected in operation 212, the user equipment 110 may perform a random access with the eNB 120 for acquiring uplink synchronization of a CC in operation 214.

In operation 216, the user equipment 110 may transmit, to the eNB 120, a connection setup request message for CC connection.

When the user equipment 110 receives a connection setup message from the eNB 120 in operation 218, the user equipment 110 may verify whether another CC is assigned to the connection setup message in operation 220.

When the other CC is assigned to the connection setup message in operation 220, the user equipment 110 may acquire downlink synchronization of the assigned CC in operation 222.

In operation 224, the user equipment 110 may verify whether a dedicated preamble of the assigned CC is included in the connection setup message.

When the dedicated preamble of the assigned CC is included in the connection setup message, the user equipment 110 may perform the random access through the assigned CC based on a contention-free scheme in operation 226.

Conversely, when the dedicated preamble of the assigned CC is not included in the connection setup message, the user equipment 110 may perform the random access through the assigned CC based on a contention scheme in operation 228.

When the other CC is not assigned to the connection setup message in operation 220, or when the random access is completely performed in operation 226 or 228, the user equipment 110 may transmit, to the eNB 120, a connection setup complete message indicating that the connection setup is completed in operation 230. Information associated with the changed CC may be included in the connection setup complete message.

FIG. 3 is a flowchart illustrating a process of changing a connection setup of a CC of the user equipment 110 in the eNB 120 of a CA environment according to an embodiment of the present invention.

Referring to FIG. 3, in operation 310, the eNB 120 may broadcast system information at predetermined time intervals. In operation 312, the eNB 120 may perform a random access with the user equipment 110 according to a request of the user equipment 110.

When a connection setup request message is received in operation 314, the eNB 120 may set up a CC of the user equipment 110 through load balancing in operation 316.

In operation 318, the eNB 120 may transmit, to the user equipment 110, a connection setup message containing CC information of the user equipment 110. In operation 320, the eNB 120 may perform the random access for connection of the CC included in the connection setup message.

In operation 322, the eNB 120 may receive, from the user equipment 110, a connection setup complete message indicating that the connection setup is completed. Information associated with the changed CC may be included in the connection setup complete message.

FIG. 4 is a flowchart illustrating a process of re-setting up a CC in the user equipment 110 of a CA environment according to an embodiment of the present invention.

Referring to FIG. 4, when the user equipment 110 detects that a radio connection of a CC being connected is disconnected, that is, when the user equipment detects a radio link failure in operation 410, the user equipment 110 may transmit, to the eNB 120, a connection state message containing information associated with the disconnected CC through another CC being connected in operation 412.

When a connection reconfiguration message is received from the eNB 120 through the connected CC in operation 414, the user equipment 110 may verify whether another CC is assigned to the connection reconfiguration message in operation 416.

When the other CC is assigned to the connection reconfiguration message in operation 416, the user equipment 110 may acquire downlink synchronization of the assigned CC in operation 418. /

In operation 420, the user equipment 110 may verify whether a dedicated preamble of the assigned CC is included in the connection reconfiguration message.

When the dedicated preamble of the assigned CC is included in the connection reconfiguration message in operation 420, the user equipment 110 may perform a random access of the assigned CC based on a contention-free scheme in operation 422.

Conversely, when the dedicated preamble of the assigned CC is not included in the connection reconfiguration message in operation 420, the user equipment 110 may perform the random access through the assigned CC based on a contention scheme in operation 424.

When the other CC is not assigned to the connection setup message in operation 416, or when the random access is completely performed in operation 422 or 424, the user equipment 110 may transmit, to the eNB 120, a connection reconfiguration complete message indicating that the connection reconfiguration is completed in operation 426. Here, information associated with the changed CC may be included in the connection reconfiguration complete message.

FIG. 5 is a flowchart illustrating a process of re-setting up a connection of a CC of the user equipment 110 in the eNB 120 of a CA environment according to an embodiment of the present invention.

Referring to FIG. 5, when an event for changing a CC of the user equipment 110 is detected in operation 510, the eNB 120 may set up a CC of the user equipment 110 to be changed through load balancing in operation 512. In this instance, the event may occur when a connection state message indicating that a component carrier of which a radio link is failed exists is received from the user equipment 110, when the eNB 120 detects that a connection state of the CC is poor, or when load balancing is required.

In operation 514, the eNB 120 may transmit, to the user equipment 110, a connection reconfiguration message containing information associated with the CC to be changed.

In operation 516, the eNB 120 may perform the random access for connection of the CC included in the connection reconfiguration message.

In operation 518, the eNB 120 may receive, from the user equipment 110, a connection reconfiguration complete message indicating that the connection reconfiguration is completed. Here, information associated with the changed CC may be included in the connection reconfiguration complete message.

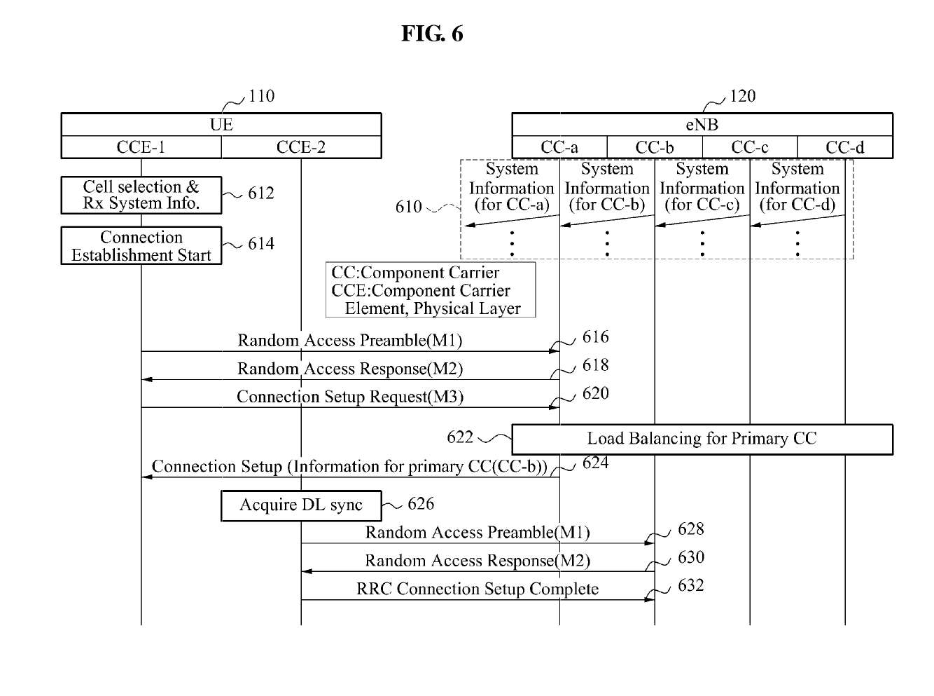

FIG. 6 is a diagram illustrating a process of changing a connection setup of a CC in a mobile communication system of a CA environment according to an embodiment of the present invention.

Referring to FIG. 6, in operation 610, the eNB 120 may broadcast system information through CC-a, CC-b, CC-c, and CC-d at predetermined time intervals.

When a power is applied to the user equipment 110, the user equipment 110 may receive system information of a cell and camp on CCE-1 in operation 612. When connection setup start is detected in operation 614, the user equipment 110 may transmit, to CC-a of the eNB 120, a random access preamble (M1) for acquiring uplink synchronization in operation 616. In operation 618, the user equipment 110 may receive a random access response (M2) from the eNB 120 and acquire uplink synchronization.

In operation 620, the user equipment 110 may transmit, to the eNB 120, a connection setup request message (M3), for example, a radio resource connection (RRC) connection setup request message for connection of CC-a.

When the connection setup request message (M3) is received, and when the user equipment 110 needs to belong to another CC based on a current carrier resource, a radio state, and the like, the eNB 120 may set up a CC to be changed through load balancing in operation 622. In operation 624, the eNB 120 may transmit, to the user equipment 110, an RRC connection setup message containing CC information to be changed, and setup information. Here, a dedicated preamble for a subsequent random access procedure or system information associated with a new CC may be included in the RRC connection setup message.

In operation 626, the user equipment 110 receiving the RRC connection setup message may acquire downlink synchronization of CCE-2 accessible through assigned CC. In operation 628, the user equipment 110 may transmit, to the eNB 120 through the assigned CC-b, a random access preamble (M1) for acquiring uplink synchronization of CCE-2. Here, when the dedicated preamble is received in operation 624, the user equipment 110 may perform a contention-free based random access procedure using the received dedicated preamble. Conversely, when no dedicated preamble is assigned from the eNB 120, the user equipment 110 may perform a contention based random access procedure.

In operation 630, the user equipment 610 may receive a random access response (M2) from the eNB 120 to acquire the uplink synchronization and set up a connection of CC-b.

In operation 632, the user equipment 110 may transmit, to the eNB 120, an RRC connection setup complete message indicating that the connection setup is completed. When a plurality of CCs is assigned from the eNB 120 to the user equipment 110 in an initial access procedure, connection setup may be performed by repeating operations 626 through 632 with respect to remaining CCs.

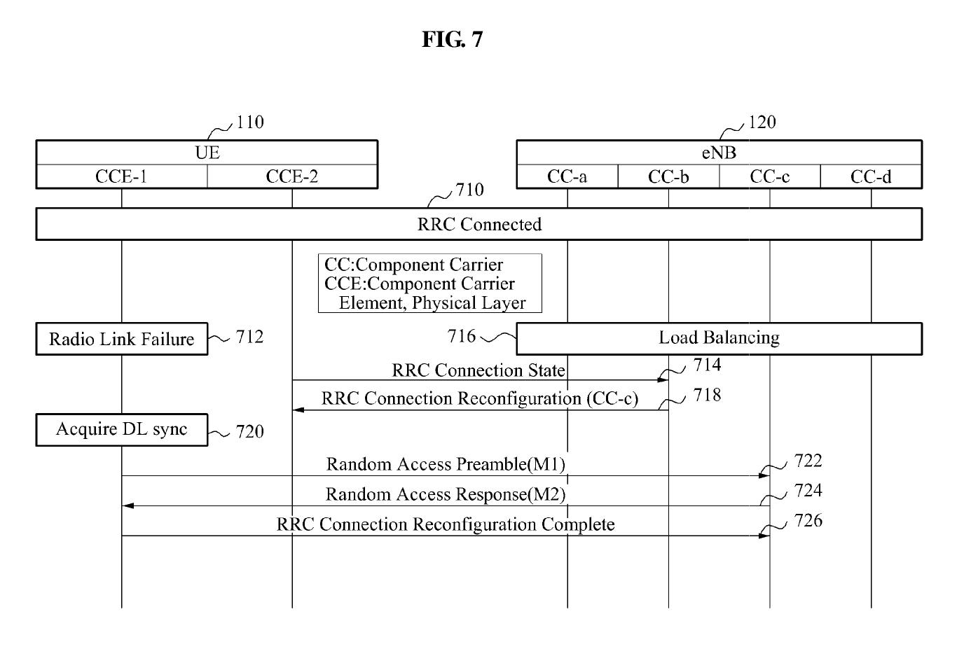

FIG. 7 is a diagram illustrating a process of re-setting up a connection of a CC in a mobile communication system of a CA environment according to an embodiment of the present invention.

Referring to FIG. 7, in operation 710, a call between the user equipment 110 and the eNB 120 may be activated. That is, the user equipment 110 and the eNB 120 may be in an RRC connected state. When the user equipment 110 detects a radio link failure in operation 712, the user equipment 110 may transmit, to the eNB 120 through another normally connected CC, an RRC connection state message containing information associated with the disconnected CC in operation 714.

When the RRC connection state message is received in operation 714, or when load balancing is required in operation 716, the eNB 120 may transmit, to the user equipment 110, an RRC connection reconfiguration message containing information associated with a CC to be changed in operation 718. Here, information associated with the changed CC may include a dedicated preamble for access of changed CC (CC-c) or system information associated with a new CC (CC-c).

In operation 720, the user equipment 110 receiving the RRC connection reconfiguration message may acquire downlink synchronization of disconnected CCE-1 using the assigned CC (CC-c).

To acquire uplink synchronization of CCE-a in operation 722, the user equipment 110 may transmit a random access preamble (M1) to the eNB 120 through the assigned CC-c. Here, when the dedicated preamble is received in operation 718, the user equipment 110 may perform a contention-free based random access procedure. When no dedicated preamble is assigned from the eNB 120, the user equipment 110 may perform a contention based random access procedure.

In operation 724, the user equipment 110 may receive a random access response (M2) from the eNB 120 to acquire the uplink synchronization and setup a connection of CC-c.

In operation 726, the user equipment 110 may transmit, to the eNB 120, an RRC connection reconfiguration complete message indicating that the connection reconfiguration is completed.

When a plurality of CCs requested from the eNB 120 to the user equipment 110 for change is included in the RRC connection reconfiguration message, operations 720 through 726 may be repeatedly performed with respect to remaining CCs.

The above-described exemplary embodiments of the present invention may be recorded in computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for setting up a connection of a component carrier in a user equipment of a mobile communication system, the method comprising:
performing a random access with an evolved node B (eNB) for acquiring uplink synchronization of the component carrier;
transmitting a connection setup request message to the eNB for the connection of the component carrier;
receiving a connection setup message from the eNB;
setting up a downlink of another component carrier when the other component carrier for connection setup is assigned to the connection setup message;
performing the random access with the eNB for acquiring an uplink synchronization of the assigned component carrier; and
transmitting a connection setup complete message to the eNB when the random access through the assigned component carrier is completed.

2. The method of claim 1, wherein the performing the random access of the assigned component carrier comprises performing the random access through the assigned component carrier based on a contention-free scheme using a dedicated preamble of the assigned component carrier when the dedicated preamble of the assigned component carrier is included in the connection setup message.

3. A method for setting up a connection of a component carrier in an evolved node B (eNB) of a mobile communication system, the method comprising:
setting up a component carrier of a user equipment through load balancing when a connection setup request message is received from the user equipment;
generating a connection setup message containing information associated with the component carrier of the user equipment;
transmitting the connection setup message to the user equipment; and
performing a random access with the user equipment through the component carrier included in the connection setup message.

4. The method of claim 3, wherein the setting up comprises setting up the component carrier of the user equipment to prevent traffic from being concentrated on a particular component carrier among component carriers used at the eNB.

5. The method of claim 3, wherein the generating comprises:
determining whether a dedicated preamble is to be assigned to the component carrier; and
generating the connection setup message by including a dedicated preamble of the component carrier in the connection setup message when the dedicated preamble is determined to be assigned to the component carrier.

6. The method of claim 3, wherein the performing comprises receiving a dedicated preamble of the component carrier from the user equipment to perform the random access based on a contention-free scheme.

7. A method of reconfiguring a connection of a component carrier in a user equipment of a mobile communication system, the method comprising:
receiving a connection reconfiguration message from an evolved node B (eNB) through a connected component carrier;
setting up a downlink of another component carrier when the other component carrier for connection reconfiguration is assigned to the connection reconfiguration message;
performing a random access with the eNB for acquiring uplink synchronization of the assigned component carrier; and
transmitting a connection reconfiguration complete message to the eNB when the random access through the assigned component carrier is completed.

8. The method of claim 7, wherein the performing comprises performing the random access through the assigned component carrier based on a contention-free scheme using a dedicated preamble of the assigned component carrier when the dedicated preamble of the assigned component carrier is included in the connection reconfiguration message.

9. The method of claim 7, further comprising:
transmitting, to the eNB, a connection state message containing information associated with a disconnected component carrier through another component carrier having a relatively good connection state, when a currently connected component carrier is disconnected.

10. A method of reconfiguring a connection of a component carrier in an evolved node B (eNB) of a mobile communication system, the method comprising:
detecting an event for changing a component carrier of a user equipment;
setting up the component carrier of the user equipment to be changed through load balancing;
generating a connection reconfiguration message containing information associated with the component carrier of the user equipment to be changed;
transmitting the connection reconfiguration message to the user equipment; and
performing a random access through the component carrier to be changed.

11. The method of claim 10, wherein the event occurs when a connection state message indicating that a component carrier of which a radio connection is disconnected exists is received from the user equipment, when the eNB detects that a connection state of the component carrier is poor, or when load balancing is required.

12. The method of claim 10, wherein the setting up comprises setting up the component carrier of the user equipment to prevent traffic from being concentrated on a particular component carrier among component carriers used at the eNB.

13. The method of claim 10, wherein the generating comprises:
determining whether a dedicated preamble is to be assigned to the component carrier to be changed; and
generating the connection reconfiguration message by including the dedicated preamble of the component carrier to be changed in the connection reconfiguration message when the dedicated preamble is determined to be assigned.

14. The method of claim 13, wherein the performing comprises performing the random access based on a contention-free scheme by receiving, from the user equipment, the dedicated preamble of the component carrier to be changed.

15. An apparatus for setting up a connection of a component carrier in a user equipment of a mobile communication system, the apparatus comprising:
at least two component carrier elements, each to communicate with an evolved node B (eNB) using a different component carrier; and
a connection setup unit to perform a random access with the eNB for acquiring uplink synchronization of the component carrier, to transmit, to the eNB, a connection setup request message for the connection of the component carrier, and to perform the random access with the eNB for acquiring uplink synchronization of an assigned another component carrier when a connection setup message assigned with the other component carrier for connection setup is received from the eNB.

16. The apparatus of claim 15, wherein when a connection reconfiguration message assigned with another component carrier for connection reconfiguration is received from the eNB through a connected component carrier, the connection setup unit sets up downlink of the assigned component carrier and performs the random access with the eNB for acquiring uplink synchronization of the assigned component carrier.

17. An apparatus for setting up a connection of a component carrier in an evolved node B (eNB) of a mobile communication system, the apparatus comprising:
at least two component carrier elements, each to perform a communication using a different component carrier; and
a connection setup unit to set up a component carrier of a user equipment through load balancing when a connection setup request message is received from the user equipment, to transmit, to the user equipment, a connection setup message containing information associated with the component carrier of the user equipment, and to perform a random access with the user equipment through the component carrier.

18. The apparatus of claim 17, wherein when an event for changing the component carrier of the user equipment is detected, the connection setup unit sets up the component carrier of the user equipment to be changed through load balancing, transmits, to the user equipment, a connection reconfiguration message containing information associated with the component carrier of the user equipment to be changed, and performs the random access through the component carrier to be changed.
